(19) United States
(12) Patent Application Publication
(10) Pub. No.: US 2016/0190890 A1
(43) Pub. Date: Jun. 30, 2016

(54) Brushed Direct Current Motor

(71) Applicant: Johnson Electric S.A., Murten (CH)

(72) Inventors: Fei Liu, Shenzhen (CN); Rui Feng Qin, Hong Kong (CN)

(21) Appl. No.: 14/986,118

(22) Filed: Dec. 31, 2015

(30) Foreign Application Priority Data
Dec. 31, 2014 (CN) 201410855959.3
Mar. 5, 2015 (CN) 201510098531.3

(51) Int. Cl. H02K 3/28; H02K 13/00; H02K 13/04

(52) U.S. Cl. CPC H02K 3/28; H02K 13/04; H02K 13/006

(57) ABSTRACT

A brushed DC motor has a stator and a rotor. The stator has 2P magnetic poles, where P is an integer greater than 1; the rotor includes a shaft, a rotor core, a commutator and a winding. The rotor core has m×P teeth; the commutator has n×P segments, where n is an integral multiple of m, and the winding includes several coil windings wound on the teeth and electrically connected to a respective segment. The segments are divided into n groups, each group having P segments electrically interconnected by an equalizer. An equalizer for at least one group of the n groups of segments and all the coil windings are formed by a single winding wire, continuously wound.

### CROSS REFERENCE TO RELATED APPLICATIONS

This non-provisional patent application claims priority under 35 U.S.C. §119(a) from Patent Application No. 201410855959.3 filed in The People's Republic of China on Dec. 31, 2014, and from Patent Application No. 201510098531.3 filed in The People's Republic of China on Mar. 5, 2015, the entire contents of which are hereby incorporated by reference.

### FIELD OF THE INVENTION

This invention relates to electric motors and in particular, to a direct current (DC) motor having brushes.

### BACKGROUND OF THE INVENTION

A conventional brushed DC motor includes a stator and a rotor, the rotor includes a shaft, a commutator fixed to the shaft, a rotor core fixed to the shaft, a winding wound about the rotor core and electrically connected to segments of the commutator. The stator has electric brushes electrically connected to the segments, thereby supplying power to the winding.

In order to reduce the number of electric brushes, an equalizer in the form of a lead wire is generally added to the commutator, and several segments connected to a same equalizer are equipotential. Hence, when one of the several segments is connected to an electric brush it is equivalent to all of the several segments are all connected to the electric brush.

Conventional commutators having an equalizer have a complex structure, with a low manufacturing efficiency.

### SUMMARY OF THE INVENTION

Hence there is a desire for a wound rotor having an improved winding arrangement, including the use of equalizers.

Accordingly, in one aspect thereof, the present invention provides a brushed DC motor, comprising: a stator comprising 2P magnetic poles, wherein P is an integer greater than 1; a rotor rotatably mounted to the stator, wherein the rotor comprises a shaft, a rotor core fixed to the shaft, a commutator and a winding; the rotor core having m×P teeth, where m is an integer greater than 2; the commutator has n×P segments, where n is an integral multiple of m; and the winding comprises a plurality of coil windings wound on the teeth and electrically connected to a respective segment, wherein the n×P segments are divided into n groups, each group has P segments, the P segments are electrically connected together via a respective equalizer, and wherein the equalizer for at least one group of the n groups of segments and all of the coil windings are formed by a continuous single winding wire.

Preferably, each of the equalizers forms a closed loop.

Preferably, P is equal to 3, m is equal to 3 and n is equal to 3.

Preferably, each of the segments comprises two hooks side by side.

Preferably, the equalizer for one group of the n groups of segments and all of the coil windings are formed by a continuous portion of the winding wire; and the winding wire of the equalizer for each group of the remaining (n−1) groups of segments is cut after a closed loop is formed.

Preferably, all of the equalizers and all of the coil windings of the rotor are formed by the continuous, single winding wire.

Preferably, a few of the coil windings and all of the equalizers are formed alternately and the remaining coil windings are formed sequentially.

Preferably, each of the coil windings is wound on a respective tooth, and two ends of the coil winding extend around the shaft by a mechanical angle of at least 90 degrees and are hooked up to two segments separated by one segment from opposite sides of the shaft respectively.

Preferably, each of the coil windings comprises P sub-coils, the P sub-coils are wound on the P teeth of the rotor respectively; and a distance between two adjacent sub-coils of the P sub-coils is an even multiple of a pole pitch.

Preferably, the stator has two electric brushes electrically connected to segments of the commutator, and two branches are formed by the winding of the rotor to be connected in parallel to the two electric brushes.

Alternatively, the stator has two electric brushes electrically connected to segments of the commutator, and six parallel branches are formed by the winding to be connected to the two electric brushes.

Preferably, the following relational expression is met for the electric brushes and the commutator of the stator:

$${W}_{b} < {D}_{c} \cdot sin ( \frac{π}{2 mP} ) + δ$$

wherein W_{b} indicates a width of the electric brush in a rotational direction of the commutator;
D_{c} indicates an outside diameter of the commutator; and
δ indicates a width of a gap between two adjacent segments of the commutator.

Hereinafter, the present invention is described by taking reference to a permanent magnet brushed DC motor having six poles and nine slots as an example. It should be realized that, the present invention is not limited to the brushed DC motor having six poles and nine slots.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is an exploded isometric view of a permanent magnet brushed DC motor according to a first embodiment of the present invention;

FIG. 2 shows a rotor of the motor of FIG. 1;

FIG. 3 is a schematic winding diagram for the rotor of FIG. 2;

FIG. 4 is a schematic top view of the rotor winding of FIG. 3, imposed on a core of the rotor;

FIG. 5 is a winding table for the rotor winding of FIG. 3;

FIG. 6 is a schematic winding diagram for a rotor winding according to a second embodiment of the present invention;

FIG. 7 is a schematic top view of the rotor winding of FIG. 6;

FIG. 8 is a winding table for the rotor winding of FIG. 6;

FIG. 9 is a schematic winding diagram for a rotor winding according to a third embodiment of the present invention;

FIG. 10 is a schematic top view of the rotor winding of FIG. 9;

FIG. 11 is a winding table for the rotor winding of FIG. 9;

FIG. 12 is a schematic winding diagram of a rotor winding according to a fourth embodiment of the present invention;

FIG. 13 is a schematic top view of the rotor winding of FIG. 12, imposed on a rotor core;

FIG. 14 is a winding table for the rotor winding of FIG. 12;

FIG. 15 is a schematic winding diagram for a rotor winding according to a fifth embodiment of the present invention;

FIG. 16 is a schematic top view of the rotor winding of FIG. 15; and

FIG. 17 is a winding table for the rotor winding of FIG. 15.

### DETAILED DESCRIPTION OF THE PREFERRED EMBODIMENTS

### First Embodiment

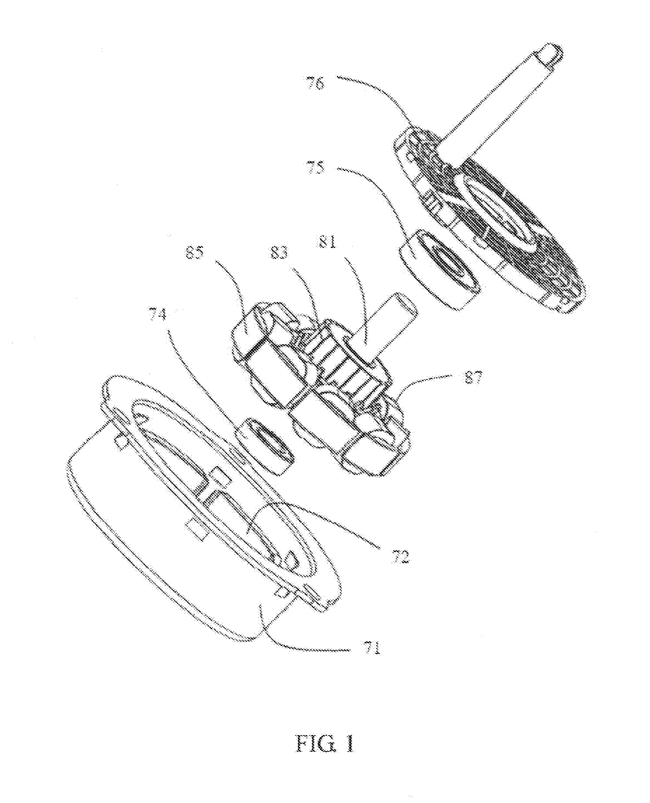

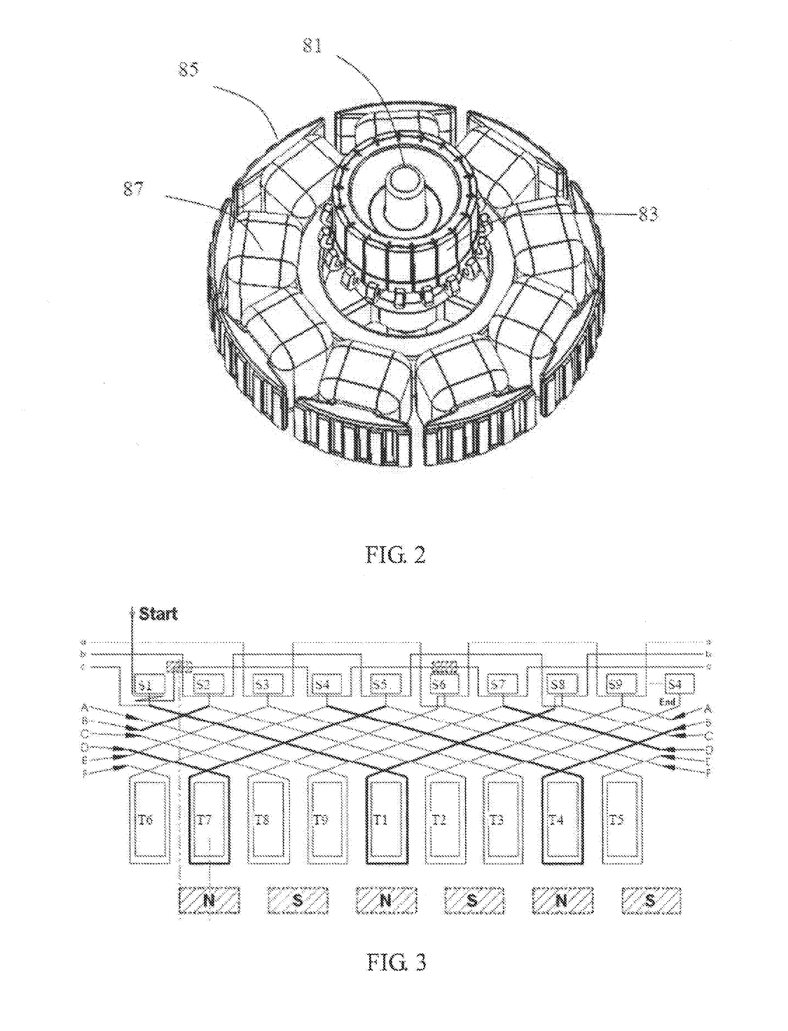

Referring to FIGS. 1 and 2, the motor according to the first embodiment includes a stator and a rotor.

The stator includes a housing 71, a number of permanent magnets 72 mounted on an inner wall of the housing, an end cap 76 mounted to an open end of the housing, a bearing 74 mounted on the housing 71 and a bearing 75 mounted on the end cap 76. Six magnetic poles are formed by the permanent magnets 72. P is equal to 3 (that is, 2P is equal to 6) in this embodiment, where P indicates the number of pole pairs of the motor.

The rotor includes a shaft 81, a commutator 83 fixed to the shaft 81, a rotor core 85 and a winding 87. The shaft 81 is journalled in the bearings 74 and 75 so that the rotor is rotatable relative to the stator.

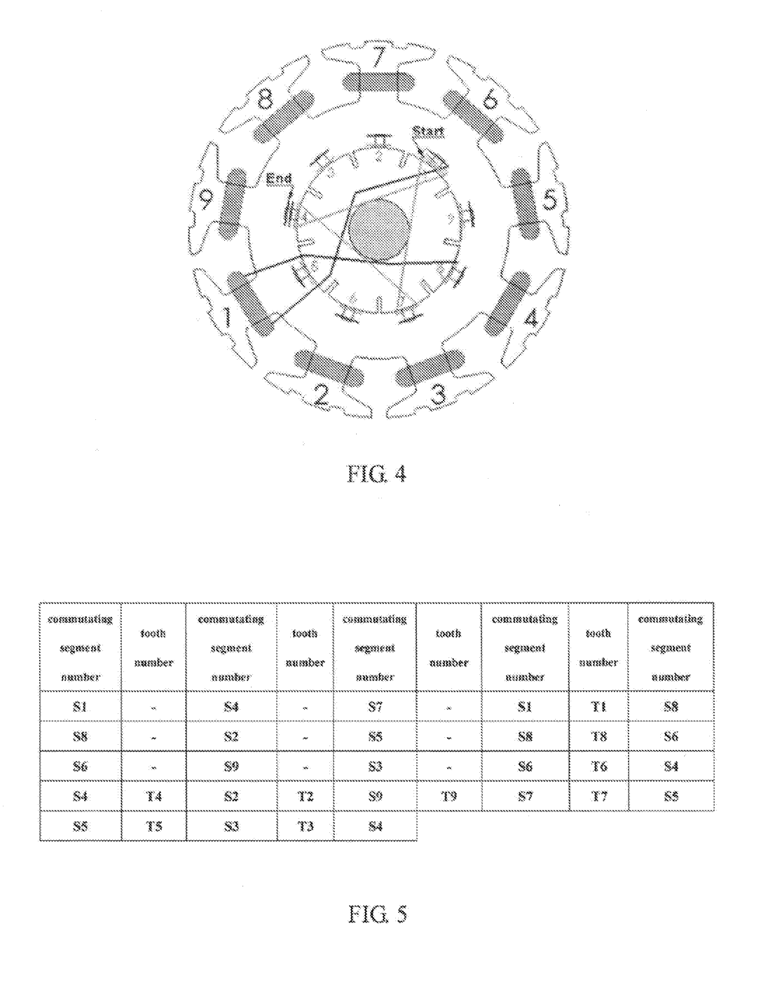

Referring to FIGS. 3 to 5, the rotor core 85 has nine teeth T1 to T9, and a winding slot is formed between adjacent teeth for accommodating coils of the winding 87. In the embodiment, the number of teeth of the rotor is an integral multiple of the number of pole pairs of the stator. P is equal to 3 and m is also equal to 3 where m×P indicates the number of teeth of the rotor. One pole pitch corresponds to 9/6 teeth (that is 1.5 teeth) where the number of teeth indicates a pole pitch correspondingly (the pole pitch refers to a distance between an S pole and an adjacent N pole).

In this embodiment, the commutator has nine commutator segments S1 to S9, the number of the segments S1 to S9 is equal to the number of teeth. Both n and m are equal to 3 where n×P indicates the number of segments. The present invention may be applied to a motor in which the number of the segments is an integral multiple of the number of teeth.

Hereinafter, the rotor winding and equalizers for the commutator 83 according to the embodiment are described in conjunction with FIGS. 3 to 5. In FIG. 3, two rectangular blocks in the first row indicate two electric brushes of the stator, where a polarity of one electric brush is positive and a polarity of the other electric brush is negative. Rectangular blocks in the second row indicate nine segments S1 to S9 of the commutator. It should be noted that segment S4 in FIG. 3 is repeated. Rectangular blocks vertically arranged in the third row indicate nine teeth T1 to T9 of the rotor. Rectangular blocks horizontally arranged in the last row indicate six magnetic poles of the stator, which includes three N poles and three S poles, where the N poles and the S poles are arranged alternately.

It is known by those skilled in the art that, segments at a distance of two (or an integral multiple of 2) pole pitches are equipotential segments, in other words, equipotential segments correspond to the permanent magnet 72 in a same magnetic pole. In the current embodiment, where the number of the segments indicates a distance between equipotential segments, one pole pitch corresponds to 9/6 segments (that is 1.5 segments), a distance between equipotential segments is equal to two pole pitches corresponding to three segments. For example, the segment S1, the segment S4 and the segment S7 are a group of equipotential segments. Similarly, segments S2, S5 and S8 are a group of equipotential segments, and the segments S3, S6 and S9 are a group of equipotential segments. The nine segments are divided into three groups (n is equal to 3), and each group has three segments (P is equal to 3). For a motor having 2P magnetic poles and n×P segments, the segments may be divided into n groups, and each group has P equipotential segments.

In the embodiment, the winding wire is hooked up to the segment S1, then the winding wire is hooked up to the segment S4 and the segment S7 sequentially and returned to the segment S1, and thus a closed-loop equalizer is formed, with which the segment S1, the segment S4 and the segment S7 are electrically shorted together.

Next, the winding wire is wound around the tooth T1 by several turns from the segment S1, then the winding wire is hooked up to the segment S8, and thus a coil winding is formed, of which two ends are electrically connected to the segment S1 and the segment S8 respectively. In the embodiment, the segment S1 and the segment S8 are opposite to the tooth T1 separated by the shaft, in other words, two ends of a coil winding wound on the tooth T1 are hooked up to two segments S1 and S8 opposite to the tooth T1 respectively. Hence, it is equivalent that two ends of the coil winding are wound around the shaft by a mechanical angle of almost 180 degrees. In practice, the two ends are located between the commutator and the rotor core. Furthermore, the ends of the coil winding may be wound around the shaft by a mechanical angle in a range from 90 degrees to 180 degrees.

Next, the winding wire is hooked up to the segment S2 and the segment S5 sequentially from the segment S8 and returned to the segment S8, and thus a closed-loop equalizer is formed, with which the segments S8, S2 and S5 are shorted together.

Next, the winding wire is wound around the tooth T8 by several turns from the segment S8, then the winding wire is hooked up to the segment S6, and thus a coil winding is formed. Similarly, the segment S8 and the segment S6 are opposite to the tooth T8 separated by the shaft. Hence, it is equivalent that two ends of the coil winding are wound around the shaft by a mechanical angle of almost 180 degrees.

Similarly, the winding wire is hooked up to the segment S3 and the segment S9 sequentially from the segment S6 and returned to the segment S6, and thus a closed-loop equalizer is formed, with which the segment S6, the segment S3 and the segment S9 are shorted together. At this point, all of the equalizers of the commutator have been wound.

Next, the winding wire is wound around the tooth T6 by several turns from the segment S6, then the winding wire is hooked up to the segment S4, and thus a coil winding is formed. Similarly, the segment S6 and the segment S4 are opposite to the tooth T6 separated by the shaft. Hence, it is equivalent that two ends of the coil winding are wound around the shaft by a mechanical angle of almost 180 degrees.

The coil windings are to be wound since the equalizers have been completed. Specifically, the winding wire is wound around the tooth T4 by several turns from the segment S4, then the winding wire is hooked up to the segment S2, and thus a coil winding is formed. The winding wire is wound around the tooth T2 by several turns from the segment S2, then the winding wire is hooked up to the segment S9, and thus a coil winding is formed. The winding wire is wound around the tooth T9 by several turns from the segment S9, then the winding wire is hooked up to the segment S7, and thus a coil winding is formed. The winding wire is wound around the tooth T7 by several turns from the segment S7, then the winding wire is hooked up to the segment S5, and thus a coil winding is formed. The winding wire is wound around the tooth T5 by several turns from the segment S5, then the winding wire is hooked up to the segment S3, and thus a coil winding is formed. The winding wire is wound around the tooth T3 by several turns from the segment S3, then the winding wire is hooked up to the segment S4, and thus a coil winding is formed, and the winding is complete. One end of the coil winding wound on the tooth T3 being connected to the segment S1 is equivalent to the end of the coil winding wound on the tooth T3 being connected to the segment S4 in a circuit since the segment S4 and the segment S1 are equipotential.

As mentioned above, in the embodiment, all the equalizers for the rotor and all the coil windings of the rotor are formed by a continuous single winding wire. There is no need to cut off the winding wire and the winding wire length is shortened, thereby improving the production efficiency significantly.

In the embodiment, the equalizers and a few of the coil windings are formed alternately in a continuous winding process using a single winding wire. The remaining coil windings are formed by the same winding wire wound continuously without cutting, after the equalizers have been wound completely.

In the embodiment, six parallel branches are formed by the rotor winding to be connected in parallel to the two electric brushes in cooperation with the equalizer although only two electric brushes are used in the stator.

### Second Embodiment

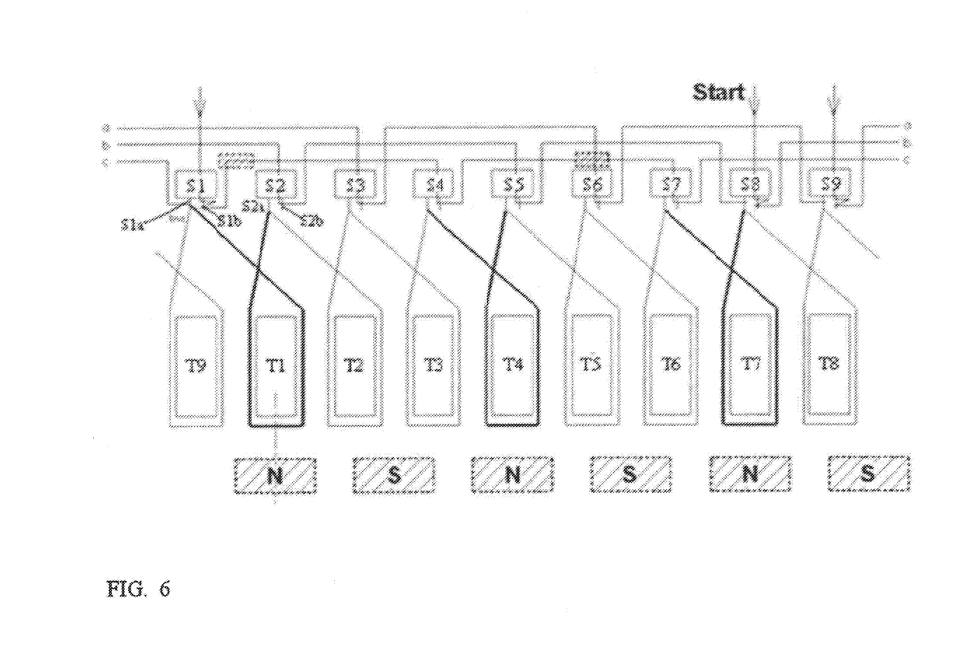

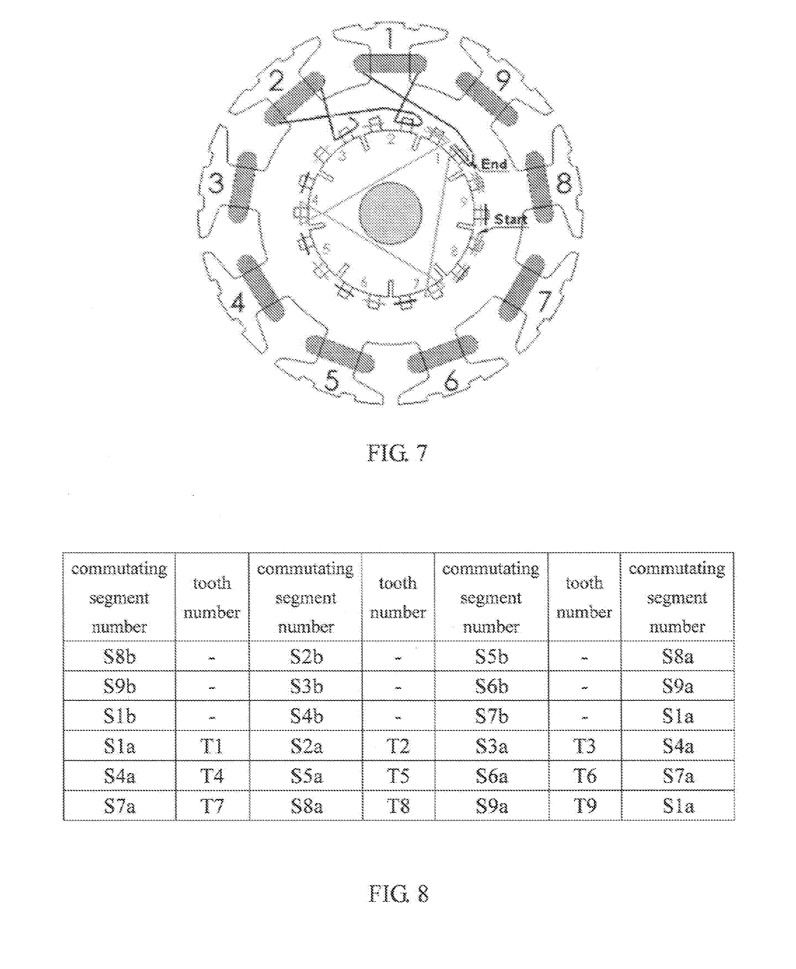

Referring to FIGS. 6 to 8, a motor according to the second embodiment of the present invention comprises a stator having six magnetic poles (that is, 2P is equal to 6) and two electric brushes, a rotor having nine teeth T1 to T9 (that is, m×P is equal to 9), and a commutator having nine segments S1 to S9 (that is, n×P is equal to 9). The embodiment differs from the above-described first embodiment in that each of the segments has a first hook for connecting an equalizer and a second hook for connecting a coil winding. For the convenience of description, the two hooks of the segment S1 are referred to as hook S1a and hook S1b respectively, and the two hooks of the segment S2 are referred to as hook S2a and hook S2b respectively, and so on.

In this embodiment, the equalizers are still formed by a winding wire of the winding. Specifically, a closed-loop equalizer is connected to the segment S8, the segment S2 and the segment S5, with connection points of hook S8b, hook S2b and hook S5b respectively, then the closed-loop equalizer is returned to the segment S8 and is connected to a hook S8a; a closed-loop equalizer is connected to the segments S9, S3 and S6, with connection points of hook S9b, hook S3b and hook S6b respectively, then the closed-loop equalizer is returned to the segment S9 and is connected to a hook S9a; and a closed-loop equalizer is connected to the segments S1, S4 and S7, with connection points of hook S1b, hook S4b and hook S7b respectively, then the closed-loop equalizer is returned to the segment S1 and is connected to the hook S1a.

In the embodiment, after a closed loop is formed by the equalizer at the hook S1a of the segment S1, the equalizer is wound around the tooth T1 by several turns, then the equalizer is hooked up to the hook S2a of the segment S2, and thus a coil winding is formed. Next, the winding wire is wound around the tooth T2 by several turns from the hook S2a, then the winding wire is hooked up to the hook S3a of the adjacent segment S3 and so on, until all the coil windings are wound.

An equalizer for one group of segments (that is, the segment S1, the segment S4 and the segment S7) of the three groups of segments in the embodiment and all the coil windings are formed by a continuously wound single winding wire; and the wire is cut off after a closed loop equalizer is formed for each group of the remaining two groups of segments.

In this embodiment, only three hooks are needed to hook up wires (including the winding wire and the equalizer) twice, and the other hooks are only needed to hook up wires once, thereby improving the reliability of automatic winding.

In this embodiment, six parallel branches are formed by the rotor winding to be connected in parallel to the two electric brushes in cooperation with the equalizer although the motor has only two electric brushes.

### Third Embodiment

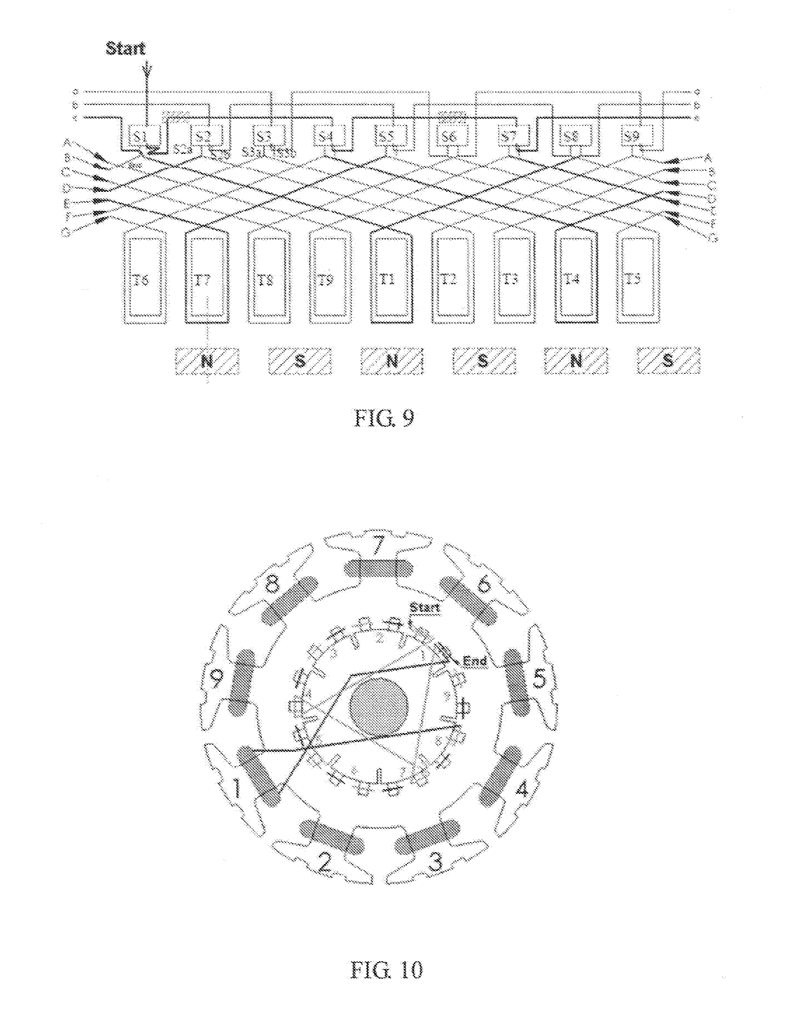

Referring to FIGS. 9, 10 and 11, a motor according to the third embodiment of the present invention comprises a stator also having has six magnetic poles (that is, 2P is equal to 6) and two electric brushes, a rotor having nine teeth T1 to T9 (that is, m×P is equal to 9), and a commutator having nine segments S1 to S9 (that is, n×P is equal to 9). The third embodiment differs from the above-described first embodiment in that each of the segments has a first hook for connecting an equalizer and a second hook for connecting a coil winding. For the convenience of description, two hooks of the segment S1 are referred to as hook S1a and hook S1b respectively, and two hooks of the segment S2 are referred to as hook S2a and hook S2b respectively, and so on.

In this embodiment, the equalizers are still formed by a winding wire of the winding, and all the equalizers and all the coil windings of the rotor are formed by a continuous single winding wire. The winding wire is connected to the second hook S1b of the segment S1, a hook S4b of the segment S4 and a hook S7b of the segment S7, sequentially, then the other hook S1a of the segment S1, and thus a closed loop equalizer is formed. Next, as the winding wire is not cut off, the winding wire is wound around the tooth T1 by several turns from the hook S1a, then the winding wire is hooked up to a hook S8b of the segment S8, and thus a coil winding is formed. It is noted that both ends of the coil winding are wound around the shaft by a mechanical angle of almost 180 degrees.

Next, the winding wire is connected to the hook S2b of the segment S2 and a hook S5b of the segment S5 sequentially from the hook S8b of the segment S8, then the winding wire is returned to the other hook S8a of the segment S8, and thus another closed loop equalizer is formed. Then the winding wire is wound around the tooth T8 by several turns to form a coil winding, and the winding wire is connected to a hook S6b of the segment S6. Similarly, it is noted that two ends of the coil winding are wound around the shaft by a mechanical angle of almost 180 degrees.

Similarly, the winding wire continues from the hook S6b of the segment S6, to a hook S9b of the segment S9 and a hook S3b of the segment S3 then the winding wire is returned to a hook S6a of the segment S6, and thus another closed loop equalizer is formed. Then the winding wire is wound around the tooth T6 to form a coil winding, and the winding wire is hooked up to a hook S4a of the segment S4.

At this point, three closed-loop equalizers and three coil windings are formed by the winding wire forming an equalizer and an coil winding alternately, and each of the segments is connected to a corresponding closed-loop equalizer. Next, only coil windings remain to be wound. The winding wire is wound around the tooth T4 by several turns from the hook S4a of the segment S4 to form a coil winding, then the winding wire is hooked up to the hook S2a of the segment S2; the winding wire is wound around the tooth T2 by several turns to form a coil winding, then the winding wire is hooked up to a hook S9a of the segment S9; the winding wire is wound around the tooth T9 by several turns to form a coil winding, then the winding wire is hooked up to a hook S7a of the segment S7; the winding wire is wound around the tooth T7 by several turns to form a coil winding, then the winding wire is hooked up to a hook S5a of the segment S5; the winding wire is wound around the tooth T5 by several turns to form a coil winding, then the winding wire is hooked up to a hook S3a of the segment S3; and the winding wire is wound around the tooth T3 by several turns to form a coil winding, then the winding wire is hooked up to the hook S1a of the segment S1. At this point, all the equalizers and the coil windings are wound by a continuous, single winding wire, without cutting the winding wire, thereby improving the winding efficiency.

In the third embodiment, six parallel branches are formed by the rotor winding to be connected in parallel to the two electric brushes in cooperation with the equalizers although only two electric brushes are used.

### Fourth Embodiment

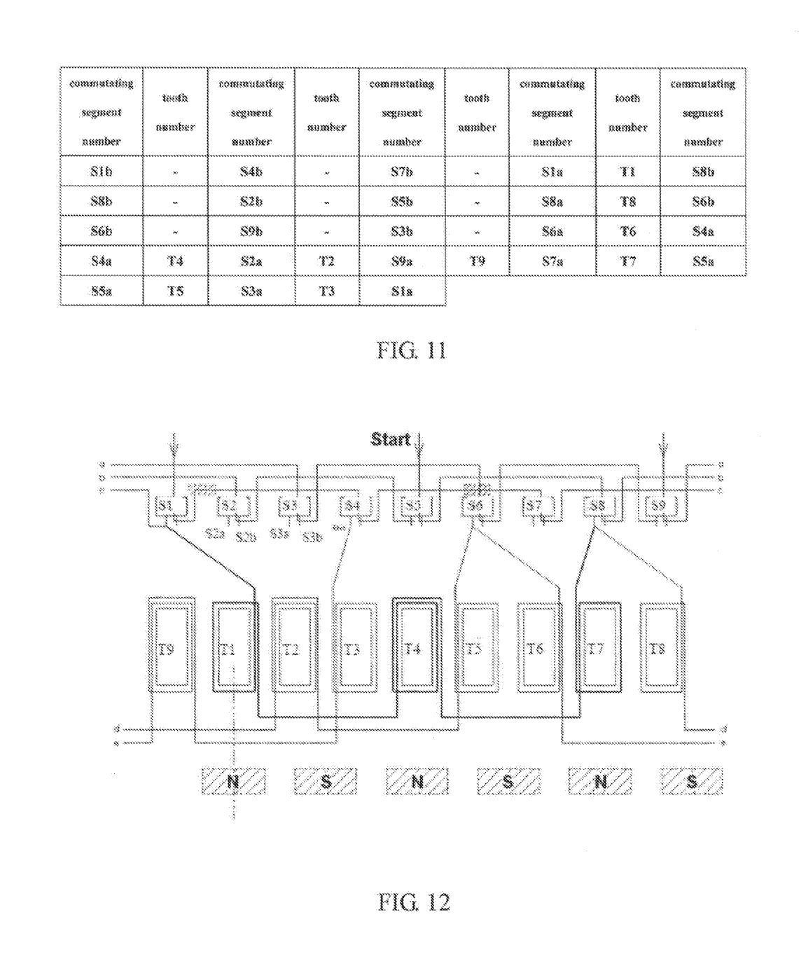

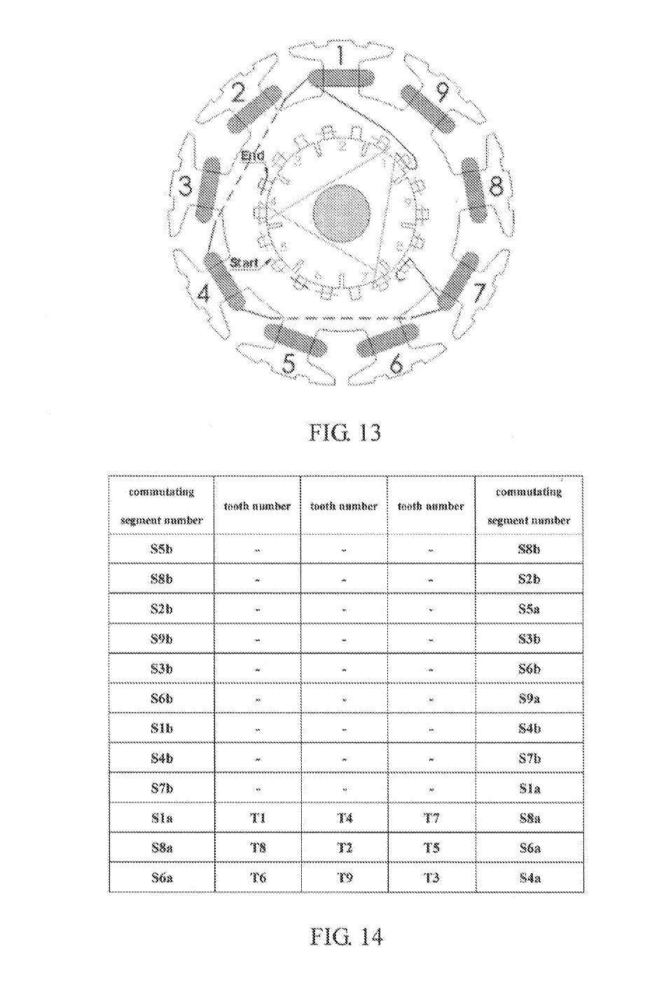

Referring to FIGS. 12, 13 and 14, a motor according to the fourth embodiment of the present invention comprises a stator having six magnetic poles (that is, 2P is equal to 6) and two electric brushes, a rotor having nine teeth T1 to T9 (that is, m×P is equal to 9), a commutator having nine segments S1 to S9 (that is, n×P is equal to 9), and each of the segments has two hooks. For the convenience of description, the two hooks of the segment S1 are referred to as hook S1a and hook S1b respectively, and two hooks of the segment S2 are referred to as hook S2a and hook S2b respectively, and so on.

In the fourth embodiment, the equalizers are still formed by a winding wire of the winding. Specifically, a closed-loop equalizer is connected to the segments S5, S8 and S2, with connection points at a hook S5b, a hook S8b and the hook S2b respectively, then the winding wire is returned to the segment S5 and is connected to a hook S5a, to close the loop; a closed-loop equalizer is connected to the segments S9, S3 and S6, with connection points of a hook S9b, a hook S3b and a hook S6b respectively, then the wire is returned to the segment S9 and is connected to a hook S9a to close the loop; and a closed-loop equalizer is connected to the segments S1, S4 and S7, with connection points of a hook S1b, a hook S4b and a hook S7b respectively, then the winding wire is returned to the segment S1 and is connected to the hook S1a to close the loop.

In this embodiment, after a closed loop equalizer is formed by the winding wire the at the hook S1a of the segment S1, the winding wire is wound around the tooth T1, the tooth T4 and the tooth T7 by several turns respectively to form a coil winding wound about three teeth, and then the wire is hooked up to a hook S8a of the segment S8. A distance between the tooth T1, the tooth T4 and the tooth T7 is even multiple of a pole pitch. In practice, nine (that is, m×P, m is equal to 3 and P is equal to 3) teeth T1 to T9 of the rotor may be divided in to three (that is m) groups, each group has three (that is P) teeth, and a distance between three teeth in each group is an even multiple of the pole pitch. In the embodiment, each of the coil windings includes three sub-coils, the three sub-coils are wound around the three teeth of the rotor respectively, a distance between two adjacent sub-coils of the three sub-elements is an even multiple of the pole pitch. In the embodiment, there are three coil windings, three sub-coils of one of the coil windings are wound around the tooth T1, the tooth T4 and the tooth T7 respectively, three sub-coils of another coil winding are wound around the tooth T8, the tooth T2 and the tooth T5 respectively, and three sub-coils of another coil winding are wound around the tooth T6, the tooth T9 and the tooth T3 respectively.

An equalizer for one group of the three groups of the segments in the embodiment and the three coil windings are formed by a continuous single winding wire, and the winding wire of the equalizer of each group of the remaining two groups of segments is cut off after a closed loop is formed.

Two parallel branches are formed to be connected in parallel to the two electric brushes by the rotor winding in cooperation with the equalizer.

### Fifth Embodiment

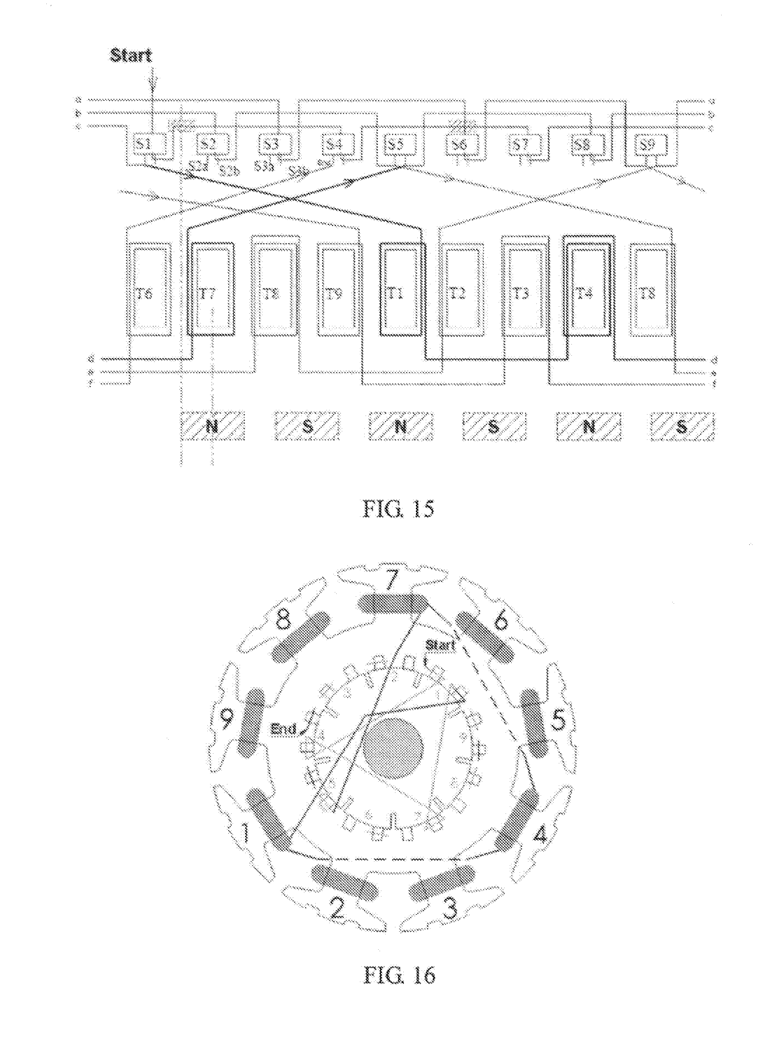

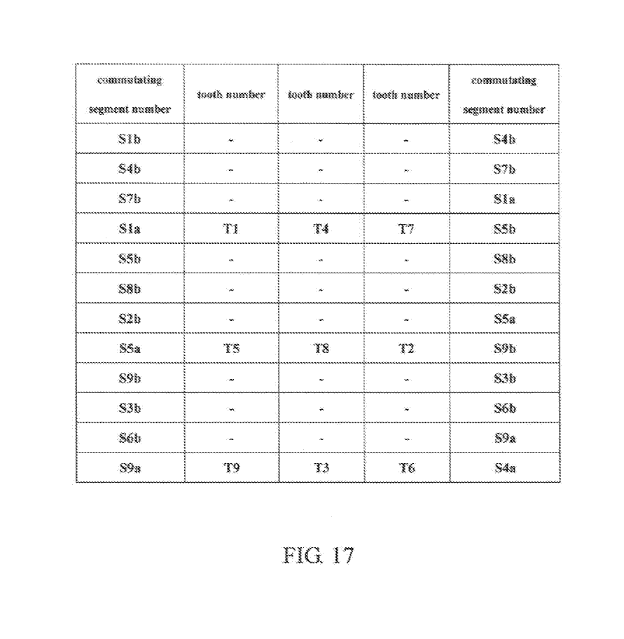

Referring to FIGS. 15, 16 and 17, a fifth embodiment of the present invention is a variation of the fourth embodiment, and differs from the fourth embodiment in that, a formation order for closed-loop equalizers and coil windings is adjusted. In the fifth embodiment, the closed-loop equalizers and the coil windings are formed alternately, and all the equalizers and the coil windings can be formed by a continuous single winding wire and the winding wire is not cut between the start and finish of the winding. Specifically, the winding wire is connected to a hook S1b of the segment S1, then to a hook S4b of the segment S4 and a hook S7b of the segment S7 sequentially, then the winding wire returns to a hook S1a of the segment S1, and thus a closed-loop equalizer is formed. Next, without cutting the wire, the winding wire is wound around the tooth T1, the tooth T4 and the tooth T7 by several turns, then the winding wire is hooked up to a hook S5b of the segment S5, and thus a coil winding is formed. Next, without cutting the wire, the segment S8 and the segment S2 are shorted sequentially via the winding wire, and the winding wire is connected to the hook S5a of the segment S5, and thus another closed-loop equalizer is formed. Next, without cutting the wire, the winding wire is wound around the tooth T5, the tooth T8 and the tooth T2 by several turns, and the winding wire is hooked up to a hook S9b of the segment S9, and thus a coil winding is formed. Similarly, the last closed-loop equalizer and the last coil winding are formed, as shown in FIG. 17.

Preferably, the following relational expression may be met for the electric brushes and the commutator of the stator:

$${W}_{b} < {D}_{c} \cdot sin ( \frac{π}{2 mP} ) + δ$$

where W_{b} indicates a width of the electric brush in a rotation direction of the commutator;
D_{c} indicates an outside diameter of the commutator; and
δ indicates a width of a gap between two adjacent segments of the commutator.

Utilization ratio for the coil windings can be further improved and it is beneficial to commutate the motor, in a case that the above-described constraint is met for the electric brush and the commutator.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A brushed DC motor, comprising:
a stator comprising 2P magnetic poles, wherein P is an integer greater than 1;
a rotor rotatably mounted to the stator, wherein the rotor comprises a shaft, a rotor core fixed to the shaft, a commutator and a winding; the rotor core having m×P teeth, where m is an integer greater than 2; the commutator has n×P segments, where n is an integral multiple of m; and the winding comprises a plurality of coil windings wound on the teeth and electrically connected to a respective segment,
wherein the n×P segments are divided into n groups, each group has P segments, the P segments are electrically connected together via a respective equalizer, and
wherein the equalizer for at least one group of the n groups of segments and all of the coil windings are formed by a continuous single winding wire.

2. The motor of claim 1, wherein each of the equalizers forms a closed loop.

3. The motor of claim 1, wherein all of the equalizers and all of the coil windings of the rotor are formed by a continuous single piece of winding wire.

4. The motor of claim 3, wherein a few of the coil windings and all of the equalizers are formed alternately and the remaining coil windings are formed sequentially.

5. The motor of claim 3, wherein each of the coil windings is wound on a respective tooth, and two ends of the coil winding extend around the shaft by a mechanical angle of at least 90 degrees and are hooked up to two segments separated by one segment from opposite sides of the shaft respectively.

6. The motor of claim 1, wherein P is equal to 3, m is equal to 3 and n is equal to 3.

7. The motor of claim 1, wherein each of the segments comprises two hooks side by side.

8. The motor of claim 7, wherein the equalizer for one group of the n groups of segments and all the coil windings are formed by a continuous portion of the winding wire; and the wire of the equalizer for each group of the remaining (n−1) groups of segments is cut after a closed loop is formed.

9. The motor of claim 8, wherein each of the coil windings comprises P sub-coils, the P sub-coils are wound on the P teeth of the rotor respectively; and a distance between two adjacent sub-coils of the P sub-coils is an even multiple of a pole pitch.

10. The motor of claim 8, wherein the stator has two electric brushes electrically connected to segments of the commutator, and two branches are formed by the winding of the rotor to be connected in parallel to the two electric brushes.

11. The motor of claim 7, wherein the stator has two electric brushes electrically connected to segments of the commutator, and six parallel branches are formed by the winding to be connected to the two electric brushes.

12. The motor of claim 7, wherein all of the equalizers and all of the coil windings of the rotor are formed by a continuous, single winding wire.

13. The motor of claim 12, wherein a few of the coil windings and all of the equalizers are formed alternately by the continuous, single winding wire, and the remaining coil windings are formed sequentially.

14. The motor of claim 12, wherein each of the coil windings is wound on a respective tooth, and two ends of the coil winding extend around the shaft by a mechanical angle of about 90 degrees and are hooked up to two segments separated by one segment from opposite sides of the shaft respectively.

15. The motor of claim 7, wherein the stator has two electric brushes electrically connected to segments of the commutator, and two branches are formed by the winding of the rotor to be connected in parallel to the two electric brushes.

16. The motor of claim 7, wherein the equalizers and the coil windings are formed alternately by the continuous single winding wire; each of the coil windings comprises P sub-coils, the P sub-coils are wound on the P teeth of the rotor respectively; and a distance between two adjacent sub-coils of the P sub-coils is an even multiple of a pole pitch.

17. The motor of claim 1, wherein the following relational expression is met for the electric brushes and the commutator of the stator:
$${W}_{b} < {D}_{c} \cdot sin ( \frac{π}{2 mP} ) + δ$$
wherein W_{b} indicates a width of the electric brush in a rotational direction of the commutator;
D_{c} indicates an outside diameter of the commutator; and
δ indicates a width of a gap between two adjacent segments of the commutator.
